(19) United States
(12) Patent Application Publication
(10) Pub. No.: US 2026/0007145 A1
(43) Pub. Date: Jan. 8, 2026

(54) VEGETABLE GUM-BASED SOFT JELLY CANDY AND PRODUCTION METHOD THEREFOR

(71) Applicant: SIRIO HEALTHCARE (ANHUI) CO., LTD., Maanshan (CN)

(72) Inventors: Ziping Yu, Maanshan (CN); Alan Cui, Maanshan (CN); Mengdan Yang, Maanshan (CN)

(21) Appl. No.: 18/881,422

(22) PCT Filed: Jun. 27, 2023
(86) PCT No.: PCT/CN2023/102820

§ 371 Date: Jan. 6, 2025

(30) Foreign Application Priority Data
Jul. 7, 2022 (CN) 202210794358.0

(51) Int. Cl. A23G 3/42; A23G 3/38; A23L 29/231; A23L 29/25; A23L 29/256; A23L 29/269; A23L 33/155; A23L 33/16; A23L 33/175

(52) U.S. Cl. CPC A23G 3/42; A23G 3/38; A23L 29/231; A23L 29/25; A23L 29/256; A23L 29/272; A23L 33/155; A23L 33/16; A23L 33/175

(57) ABSTRACT

A soft jelly candy and a production method therefor. The soft jelly candy contains the following components: a) 30-45 parts by weight of carrageenan, b) 4-15 parts by weight of agar and/or pectin, and c) 2-16 parts by weight of gum arabic and/or gellan gum. Based on the total weight of the soft jelly candy after moisture is removed, the components a), b) and c) together account for 2.37-5.86% by weight. The production method includes: uniformly mixing carrageenan, agar and/or pectin, and gum arabic and/or gellan gum with water, respectively. A “shrinkage” phenomenon does not occur to the soft jelly candy when the soft jelly candy contains a sugar alcohol and/or is high in functional component content.

### TECHNICAL FIELD OF THE INVENTION

The present disclosure relates to the field of food, particularly soft candy food processing technology. Specifically, the disclosure relates to a vegetable gum-based soft jelly candy and a preparation method thereof.

### BACKGROUND

As a snack food, a soft jelly candy is deeply loved by consumers. A gelatin soft candy is a major category of soft jelly candies and is very popular in the market due to its higher elasticity and chewiness. However, the poor thermal stability and a large addition amount of gelatin, and its single taste still limit the production and sales of the gelatin soft candy. In recent years, with the popularity of pure natural and vegetarian concepts, the vegetable gum-based soft jelly candy has attracted widespread attention in markets of the developed countries such as Europe and the United States, becoming a new consumption fashion for soft jelly candies.

The vegetable gum-based soft jelly candy has the following major advantages over a gelatin-based soft jelly candy:
suitable for special dietary requirements (halal and/or kosher food);
providing a wide range of textures, from hard to soft, from brittle to elastic textures;
with a less addition amount, which is about half of the usage amount of the gelatin; and
having shelf life stabilities, including temperature resistance and texture stability.

Due to the above advantages of a vegetable gum, the vegetable gum has become a good carrier for health-care raw materials or healthy raw materials. A jelly system is an essential part of a soft jelly candy. Candies made with different jelly systems have different physical, chemical and sensory properties. A jelly system commonly used in a vegetable gum-based soft jelly candy currently on the market mainly includes modified starch, pectin and carrageenan etc. However, there are some issues in current vegetable gum-based soft jelly candy products, among which the most prominent issue is that they are prone to “shrinkage” (specifically, the texture is destroyed, like shrinkage and damage to a sponge, see FIG. 1) during the shelf life. This issue is particularly serious for vegetable gum-based soft jelly candies containing a high content of functional ingredients (≥1% by weight of functional vitamins, minerals, oils, etc.). In addition, the “shrinkage” phenomenon in the current vegetable gum-based soft jelly candies comprising sugar alcohols is also particularly serious.

CN112401045A relates to a preparation method of a vegetable gum type soft jelly candy, which is designed to address the issue of the larger hardness and brittleness of the carrageenan gum base, which are not able to provide sufficient elasticity and chewiness, and may result in the issue of syneresis or water seepage and deterioration of the soft candy. CN112401045A addresses the above issues by utilizing a gum sugar powder including 2.4-4.0 parts by weight of K-carrageenan, 0-1.6 parts by weight of CMC and 40-60 parts by weight of sugar. However, this patent application cannot be sugar-free/low-sugar, nor can it achieve a high content of functional ingredients (≥1% of functional vitamins, minerals, oils, etc.), and therefore does not solve the problem of “shrinkage” of a vegetable gum-based soft jelly candy containing sugar alcohols and a vegetable gum-based soft jelly candy containing a high content of functional ingredients.

Therefore, there is still a need for vegetable gum-based soft jelly candy products with good product appearance stability and texture.

### SUMMARY OF THE INVENTION

Accordingly, one object of the present disclosure is to provide a vegetable gum-based soft jelly candy and a preparation method thereof, so that the vegetable gum-based soft jelly candy is more stable in the quality and the “shrinkage” phenomenon is avoided. Another object of the present disclosure is to provide a vegetable gum-based soft jelly candy and a preparation method thereof, so that the “shrinkage” phenomenon does not occur when the soft jelly candy contains sugar alcohols and/or a high content of a functional ingredient.

One aspect of the present disclosure relates to a vegetable gum-based soft jelly candy, which comprises the following components:
a) 30-45 parts by weight of carrageenan,
b) 4-15 parts by weight of agar and/or pectin, and
c) 2-16 parts by weight of arabic gum and/or gellan gum,
the components a), b) and c) together account for 2.37-5.86% by weight based on the total weight of the soft jelly candy minus moisture.

In some embodiments, the vegetable gum-based soft jelly candy further comprises 21-100 parts by weight of a functional ingredient. In some embodiments, the vegetable gum-based soft jelly candy further comprises 1200-1300 parts by weight of a sweetener. In some embodiments, the vegetable gum-based soft jelly candy is sugar-free. In some embodiments, the functional ingredient comprises a nutritional fortifier, which is one or more of the nutritional fortifiers allowed for use in the current GB14880 Standard for the use of nutritional fortifiers, for example minerals, such as calcium, iron, zinc, selenium, magnesium, potassium, sodium, copper, etc.; vitamins, such as vitamin A, vitamin D, vitamin E, vitamin C, B vitamins, folic acid, biotin, etc.; amino acids, such as taurine, lysine, etc.; other ingredients beneficial to the human body, such as docosahexaenoic acid (DHA), dietary fiber, lecithin, probiotics, etc.; preferably vitamins, minerals and DHA.

In some embodiments, the sweetener is one or more that selected from the group consisting of sorbitol, mannitol, maltitol, isomaltitol, erythritol and xylitol. In some embodiments, the vegetable gum-based soft jelly candy further comprises one or more components selected from the followings: 0-20 parts by weight of a fruit and vegetable juice, 0-20 parts by weight of a sour agent, 0-20 parts by weight of an edible essence and 0-20 parts by weight of a food pigment.

In some embodiments, the vegetable gum-based soft jelly candy comprises each of the following components:
I:
a) 36-45 parts by weight of carrageenan,
b) 8-15 parts by weight of agar and/or pectin, and
c) 8-16 parts by weight of arabic gum and/or gellan gum; or
II:
a) 30-45 parts by weight of carrageenan,
b) 4-8 parts by weight of agar and/or pectin, and
c) 2-8 parts by weight of arabic gum and/or gellan gum.

Another aspect of the present disclosure relates to a method for preparing the vegetable gum-based soft jelly candy of the present disclosure, comprising mixing homogeneously each of carrageenan, agar and/or pectin and arabic gum and/or gellan gum with water.

Another aspect of the present disclosure relates to a method for improving the appearance stability and/or texture of a vegetable gum-based soft jelly candy, comprising preparing the vegetable gum-based soft jelly candy with a) carrageenan, b) agar and/or pectin and c) arabic gum and/or gellan gum, wherein the vegetable gum-based soft jelly candy comprises the following components:
a) 30-45 parts by weight of carrageenan,
b) 4-15 parts by weight of agar and/or pectin, and
c) 2-16 parts by weight of arabic gum and/or gellan gum,
wherein the components a), b) and c) together account for 2.37-5.86% by weight based on the total weight of the soft jelly candy minus moisture.

### DESCRIPTION OF THE DRAWINGS

FIG. 1 shows a photograph of the soft jelly candy with different appearances.

FIG. 2 shows exemplary photographs of the soft candies according to examples of the present disclosure. FIG. 2a corresponds to Example 8, and FIG. 2b corresponds to Example 3.

FIG. 3 shows exemplary photographs of soft candies of the comparative example in the present disclosure. FIG. 3a corresponds to Comparative Example 17. FIG. 3b corresponds to Comparative Example 2. FIG. 3c corresponds to Comparative Example 9. FIG. 3d corresponds to Comparative Example 14. FIG. 3e corresponds to Comparative Example 20.

### DETAILED DESCRIPTION OF THE DISCLOSURE

Several aspects of the disclosure are described below with reference to examples to illustrate the present application. It should be understood that numerous specific details, relationships and methods are set forth to provide a thorough understanding of the disclosure. However, one of ordinary skilled person in the relevant art will readily recognize that the disclosure may be practiced without one or more of the specific details or may be practiced in other ways.

### Definition

The terminology used herein is for the purpose of describing particular embodiments only and is not intended to limiting the disclosure. As used herein, the singular forms “a”, “an”, and “the” are intended to include the plural forms as well, unless otherwise expressly provided herein. In addition, the open-ended expressions “comprise” and “include” are interpreted to mean that they may also contain structural components or method steps that are not mentioned, but it should be noted that the open-ended expressions also cover situations that only consist of the components and methods steps described (that is, covering situations where the close-ended expression “consists of” is used).

As used throughout herein, a range is used as a shorthand form to describe each value and all values within the range. Any numerical value within a range such as an integer value, a value that increases in tenths (when range ends with one decimal place), or a hundredth (when the range ends with two decimal places) can be selected as the ends of the range. For example, the range of 30-45 is used to describe all values within that range, such as 30, 31, 32, 33, 34, 35, 36, 37, 38, 39, 40, 41, 42, 43, 44, and 45 (all integer values), and comprises all subranges defined between any two of the preceding values, such as 30-40, 40-45, 32-42, 35-40, 37-45, etc.

The phrase “within any range defined between any two of the preceding values” as used herein literally means that any range may be selected from any two values listed preceding such phrase, regardless of whether the values are between in a lower part of the list or in a higher part of the list. For example, a pair of values can be selected from two lower values, two higher values, or one lower value and one higher value.

Sugar alcohols are polyols containing two or more hydroxyl groups, but sugar alcohols are different from polyols such as ethylene glycol, propylene glycol, and pentaerythritol synthesized in petrochemical industry. Sugar alcohols can be prepared from corresponding sugars from a wide range of sources. That is, the aldehyde or ketone group on the sugar molecule is reduced to a hydroxyl group to generate a sugar alcohol. For example, glucose is reduced to generate sorbitol. Xylose is reduced to generate xylitol. Maltose is reduced to generate maltitol. Fructose is reduced to generate mannitol. Currently developed sugar alcohols include sorbitol, mannitol, erythritol, maltitol, lactitol, xylitol, etc. These sugar alcohols have high stability under acid or heat and are not prone to Maillard reactions and become low-calorie food sweeteners and are widely used in low-calorie food formulas.

Sugar alcohols are not used by microorganisms in the oral cavity, and do not decrease but increase the oral cavity pH, so that they do not corrode teeth and are good materials for preventing dental caries. Sugar alcohols have no effect on the blood sugar levels in the human body and can provide certain calories for diabetics, and thus can be used as nutritional sweeteners to provide calories for diabetics.

The term “sugar-free” as used herein refers to a food product containing no more than 0.5 gram of carbohydrate (sugar) per 100 grams of a solid food product or 100 milliliters of a liquid food product. The term “low sugar” as used herein refers to a food product containing no more than 5 grams of carbohydrate (sugar) per 100 grams of a solid food product or 100 milliliters of a liquid food product.

Unless otherwise indicated, all parts and percentages used herein are by weight.

Unless otherwise indicated, all technical terms used herein have the meaning commonly understood by one of ordinary skilled person in the art to which this disclosure belongs.

### Soft Jelly Candy

The soft jelly candy of the present disclosure comprises a) 30-45 parts by weight of carrageenan, b) 4-15 parts by weight of agar and/or pectin, and c) 2-16 parts by weight of arabic gum and/or gellan gum wherein the components a), b) and c) together account for 2.37-5.86% by weight based on the total weight of the soft jelly candy minus moisture.

In some embodiments, carrageenan is present in the soft jelly candy in an amount of 32-45 parts by weight, 34-45 parts by weight, 35-45 parts by weight, 36-45 parts by weight, 38-45 parts by weight, 40-45 parts by weight, 33-43 parts by weight, 35-40 parts by weight or 37-40 parts by weight, or may be present in the soft jelly candy, for example, in an amount within any range defined between any two of the preceding values. In some embodiments, agar and/or pectin are present in the soft jelly candy in an amount of 6-15 parts by weight, 8-15 parts by weight, 10-15 parts by weight, 12-15 parts by weight, 14-15 parts by weight, 5-13 parts by weight, 7-11 parts by weight or 9-15 parts by weight, or may be present in the soft jelly candy, for example, in an amount within any range defined between any two of the preceding values. In some embodiments, arabic gum and/or gellan gum are present in the soft jelly candy in an amount of 4-16 parts by weight, 6-16 parts by weight, 8-16 parts by weight, 10-16 parts by weight, 12-16 parts by weight, 14-16 parts by weight, 3-15 parts by weight, 5-13 parts by weight, 7-11 parts by weight or 9-16 parts by weight, or may be present in the soft jelly candy, for example, in an amount within any range defined between any two of the preceding values. Carrageenan, agar, pectin, arabic gum and gellan gum are edible gums and are common gums in the food field. In some embodiments, the pectin is a commercial pectin or a raw pectin, or the like.

In some embodiments, based on the total weight of the soft jelly candy minus moisture, components a), b) and c) together account for 2.37-5.86 wt %, 2.44-5.86 wt %, 2.51-5.86 wt %, 3.00-5.86 wt %, 3.50-5.86 wt %, 4.00-5.86 wt %, 4.50-5.86 wt %, 5.00-5.86 wt %, 5.50-5.86 wt %, or any range defined between any two of the preceding values.

In some embodiments, the soft jelly candy further comprises 21-100 parts by weight of a functional ingredient, such as 30-100 parts by weight, 40-100 parts by weight, 50-100 parts by weight, 60-100 parts by weight, 70-100 parts by weight, 80-100 parts by weight, 90-100 parts by weight, or within any range defined between any two of the preceding values. In some embodiments, the functional ingredient comprises a nutritional fortifier, which is one or more of the nutritional fortifiers allowed for use in the current GB14880 Standard for the use of nutritional fortifiers, for example minerals, such as calcium, iron, zinc, selenium, magnesium, potassium, sodium, copper, etc.; vitamins, such as vitamin A, vitamin D, vitamin E, vitamin C, B vitamins, folic acid, biotin, etc.; amino acids, such as taurine, lysine, etc.; other ingredients beneficial to the human body, such as docosahexaenoic acid (DHA), EPA, dietary fiber, lecithin, probiotics (such as, yeast, some spore-producing bacillus (such as, Bacillus coagulans), Clostridium butyricum, Lactobacillus (e.g., one or more of Lactobacillus casei, Lactobacillus acidophilus, Lactobacillus rhamnosus, Lactobacillus plantarum, Lactobacillus reuteri, Lactobacillus salivarius, Lactobacillus helveticus, Lactobacillus paracasei, Lactobacillus bulgaricus, Lactobacillus fermentum, etc.), Bifidobacterium (e.g., one or more of Bifidobacterium lactis, Bifidobacterium infantis, Bifidobacterium longum, Bifidobacterium breve, Bifidobacterium adolescentis, etc.), one or more of Actinomycetes sp., etc.), etc.; preferably vitamins, minerals and DHA. In some embodiments, the functional ingredient is one or more of the nutritional fortifiers allowed for use in the current GB14880 Standard for the use of nutritional fortifiers. In some embodiments, the functional ingredient comprises edible oil, for example, one or a combination selected from: algae oil such as DHA algae oil, fish oil, linseed oil, krill oil, sunflower oil or a combination thereof.

In some embodiments, the soft jelly candy further comprises 1200-1300 parts by weight of a sweetener, such as 1220-1300 parts by weight, 1240-1300 parts by weight, 1260-1300 parts by weight, 1280-1300 parts by weight, or any range defined between any two of the preceding values. In some embodiments, the sweetener is one or more that selected from the group consisting of sorbitol, mannitol, maltitol, isomaltitol, erythritol and xylitol.

In some embodiments, the soft jelly candy further comprises one or more components selected from: 0-20 parts by weight (such as 0-15 parts by weight, 0-10 parts by weight, 0-8 parts by weight, 0-6 parts by weight, 0-4 parts by weight, 0-2 parts by weight, 1-5 parts by weight, 6-15 parts by weight, 8-15 parts by weight or any range defined between any two of the preceding values) of a fruit and vegetable juice, 0-20 parts by weight (such as 0-15 parts by weight, 0-10 parts by weight, 0-8 parts by weight, 0-6 parts by weight, 0-4 parts by weight, 0-2 parts by weight, 1-5 parts by weight, 6-15 parts by weight, 8-15 parts by weight or any range defined between any two of the preceding values) of a sour agent, 0-20 parts by weight (such as 0-15 parts by weight, 0-10 parts by weight, 0-8 parts by weight, 0-6 parts by weight, 0-4 parts by weight, 0-2 parts by weight, 1-5 parts by weight, 6-15 parts by weight, 8-15 parts by weight or any range defined between any two of the preceding values) of an edible essence and 0-20 parts by weight (such as 0-15 parts by weight, 0-10 parts by weight, 0-8 parts by weight, 0-6 parts by weight, 0-4 parts by weight, 0-2 parts by weight, 1-5 parts by weight, 6-15 parts by weight, 8-15 parts by weight or any range defined between any two of the preceding values) of a food pigment.

In some embodiments, the fruit and vegetable juice is concentrated juices of various fruits, such as strawberry, apple, grape, sweet orange, pineapple, mango, peach, pear, watermelon, pomegranate, durian, grapefruit and others, or fruit and vegetable juice beverage products specified in GB/T 31121 Fruit and Vegetable Juice and Beverages, or a mixture of one or more.

In some embodiments, the sour agent is one or a mixture of two or more of citric acid, malic acid, sodium citrate, lactic acid, tartaric acid, and fumaric acid.

In some embodiments, the edible essence is food essence, for example, one or more selected from the followings: orange essence, lemon essence, strawberry essence, raspberry essence, blueberry essence, peach essence, cola essence, cherry essence, banana essence, pear essence, black carrot essence, complex berry essence, grape essence, Chinese-date essence, lychee essence, Lycium barbarum essence, pomegranate essence, blackcurrant essence, carrot essence, raspberry essence, noni essence, ebony essence, fermented fruit and vegetable essence, cranberry essence, green plum essence, sea buckthorn essence, kiwi essence, mango essence, mixed fruit essence, cucumber essence, caramel essence, coffee essence and honey essence. In some embodiments, the food pigment is selected from one or more of the followings: annatto, carmine, beta carotene, turmeric, caramel, titanium dioxide, lemon yellow, brilliant blue, allure red, chili red, grape skin red, red yeast rice, beet red, gardenia blue, gardenia yellow, radish red, sunset yellow, sodium copper chlorophyllin, iron oxide, safflower yellow, amaranth red, erythrosine, indigo, new red, vegetable carbon black and lutein.

In addition, the soft jelly candy of the present disclosure may also optionally comprise other additives and ingredients. The soft jelly candy may include candy flavorings, such as peanut butter flavoring, vanilla flavoring, chocolate flavoring, etc. and combinations thereof. The soft jelly candy may further comprise a processing aid, such as processing aids commonly used in candy processes. Additional flavorings, seasonings, colorants, inclusions, preservatives, antioxidants, excipients, etc. and combinations thereof may also be included in the soft jelly candy in small amounts.

In some embodiments, preferred vitamins are, such as, vitamin A, vitamin C, vitamin D, vitamin E, vitamin K, and derivatives and/or provitamins thereof. Preferred vitamins also include B vitamins such as biotin, folic acid, niacin, nicotinamide, pantothenate, pyridoxine hydrochloride, riboflavin, thiamine hydrochloride, and the like. Minerals may include, but are not limited to, bromine, calcium, chromium, copper, iodine, iron, magnesium, manganese, phosphate, phosphorus, potassium, selenium, sodium, sulfur, and zinc. Amino acids include, such as, arginine, histidine, isoleucine, leucine, lysine, methionine, phenylalanine, threonine, tryptophan, valine, alanine, aspartic acid, glutamic acid, glutamine, glycine, serine, tyrosine, creatine, etc.

### Preparation Method

The soft jelly candy of the present disclosure can be prepared as follows:

### (1) Preparation of Gum Solution

Each of carrageenan, agar/pectin, arabic gum/gellan gum are mixed with water homogeneously and fully dissolved for future use.

### (2) Preparation of Sugar Liquid

Sugar alcohol is mixed with an appropriate amount of purified water, heated until it is completely dissolved, then the above-mentioned gum solution is added, then the resulting solution is cooked and concentrated until the solid content is 60%-90%. Optional aeration can be performed here.

### (3) Blending

The sugar liquid (2) is blended homogeneously with a functional ingredient, an optional edible essence, an optional concentrated fruit juice, an optional food pigment, an optional sour agent, etc. which are weighed, to obtain the formulated material liquid. Optionally, air bubbles can be removed here.

### (4) Casting Molding

The formulated material liquid is placed in the reservoir box of the casting machine, kept at 60° C.-100° C., and casted. The molding process adopts starch compression molding or blister cooling molding.

### (5) Drying or Cooling

Drying or cooling are performed according to the moisture content. For drying: the obtained soft candy is dried at a drying temperature of 10-50° C. and a relative humidity of 10%-70% RH. For cooling: the obtained soft candy is cooled at a drying temperature of −10-20° C.

### (6) Demolding and Post-Processing

The dried soft candy is demolded, polished or mixed with sand-like substance to obtain a functional soft candy.

Method for Improving Appearance Stability and/or Texture

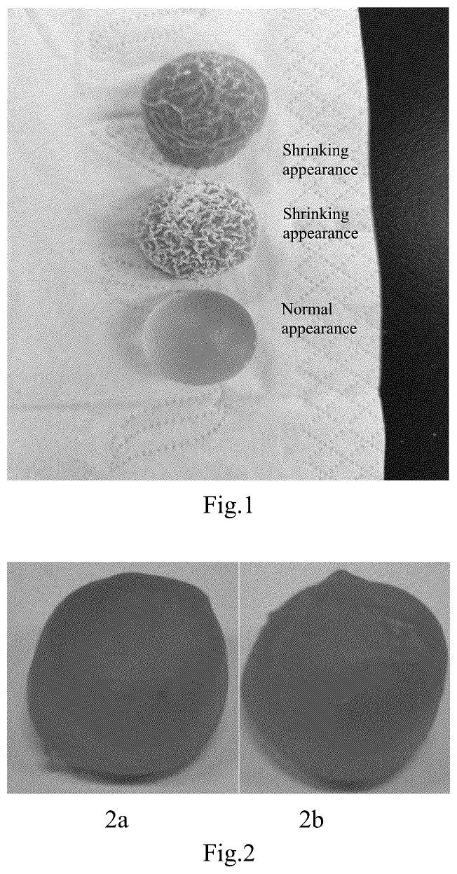

There are some issues in current vegetable gum-based soft jelly candy products, among which the most prominent issue is that they are prone to “shrinkage” (specifically, the texture is destroyed, like shrinkage and damage to a sponge, see FIG. 1) during the shelf life. This issue is particularly serious for a vegetable gum-based soft jelly candy containing a high content of a functional ingredient (≥1% by weight of functional vitamins, minerals, oils, etc.). In addition, the “shrinkage” phenomenon in a vegetable gum-based soft jelly candy comprising sugar alcohols is also particularly serious. Accordingly, in one aspect, the present disclosure relates to a method for improving the appearance stability and/or texture of a vegetable gum-based soft jelly candy, comprising preparing the vegetable gum-based soft jelly candy with a) carrageenan, b) agar and/or pectin and c) arabic gum and/or gellan gum, wherein the a) carrageenan, b) agar and/or pectin and c) arabic gum and/or gellan gum are as defined in the present disclosure in the “soft jelly candy” section. In some embodiments, the soft jelly candy may comprise other ingredients as defined in the “soft jelly candy” section of the present disclosure, such as a functional ingredient, a sweetener, a fruit and vegetable juice, a sour agent, an edible essence, an edible pigment and other additives and ingredients.

While various embodiments of the present disclosure have been described above, it should be understood that they are provided by way of example only and not limitation. Many changes to the disclosed embodiments can be made in accordance with the disclosure herein without departing from the spirit or scope of the disclosure. Accordingly, the breadth and scope of the present disclosure should not be limited by any of the above-described embodiments.

### EXAMPLES

Unless otherwise indicated, the materials used in the examples herein are all commercially available, and the various specific experimental methods used to perform the experiments are conventional experimental methods in the art or according to the steps and conditions recommended by the manufacturer, and it can be routinely determined as required by those skilled in the art.

### 1. Method

### 1.1 Preparation Process of a Soft Jelly Candy

All examples and comparative examples are prepared using the following process:

### (1) Preparation of a Gum Solution

Each of carrageenan, agar/pectin, arabic gum/gellan gum were mixed with water homogeneously to be fully dissolved for future use.

### (2) Preparation of a Sugar Liquid

A sweetener was mixed with an appropriate amount of purified water, heated until it was completely dissolved, then the above-mentioned gum solution was added, and then the resulting solution was cooked and concentrated until the solid content was 85%, kept warm for future use.

### (3) Blending

The sugar liquid (2) was blended homogeneously together with an edible essence, a concentrated fruit juice, a functional ingredient, a food pigment and a sour agent which were weighed (in addition to the ingredients listed in Tables 1-7 below, all examples and comparative examples further contain 5 parts of grapefruit concentrate juice, 5 parts of citric acid, 5 parts of lemon essence and 5 parts of annatto) to obtain the formulated material liquid. Optionally, air bubbles can be removed here.

### (4) Casting Molding

The formulated material liquid was placed in the reservoir box of the casting machine, kept at 95° C., and casted. The molding process adopts starch compression molding or blister cooling molding.

### (5) Drying

For starch compression molding, the obtained soft candy was dried at a drying temperature of 45° C. and a relative humidity of 50% RH.

### (6) Demolding and Post-Processing

The dried soft candy was demolded, polished or mixed with sand-like substance to obtain a functional soft candy.

### 1.2 Texture Test

The prepared soft candy was subjected to a texture test using the SMS TA XT plus texture analyzer according to the TPA (texture profile analysis) method. The test was performed under the following test conditions: pre-test speed: 1 mm/s, test speed: 1 mm/s, post-test speed: 1 mm/s, trigger force: 8 g, target mode: deformation 50%.

Each sample was taken for testing, in which the finished product specification and shape were controlled to be consistent, cylindrical, 4.0 g/grain, weight deviation of no more than 0.1 g. Each group of samples was tested in parallel for 6 times, and the average value was taken as the texture test result.

The same batch of samples (which had not been tested) was bottled and sealed, placed at 25±2° C., and assayed in a 40-80% humidity environment for 12 months. Elasticity and hardness were measured again.

$$Hardness retention rate = measured value at 12 months / 0 month \\ Elastic retention rate = measured value at 12 months / 0 month .$$

### 2. The Formulas and Results of Each Example and Comparative Example

TABLE 1
Formulas of Examples 1-6 (unit: parts by weight, where the amount of water is the
initial content, DHA algal oil contains ≥40% of DHA) and texture test results

| | | | | | DHA | | | |
|---|---|---|---|---|---|---|---|---|
| | | | Arabic | | algal | | Hardness | Elastic |
| | Carrageenan | Agar | gum | Maltose | oil | Purified | retention | retention |
| Example | (3243C) | (1000 g/cm²) | (SC10) | P200 | (40%) | water | rate | rate |
| 1 | 45 | 4 | 2 | 1200 | 21 | 675 | 105% | 90% |
| 2 | 45 | 15 | 16 | 1300 | 50 | 765 | 94% | 95% |
| 3 | 36 | 8 | 8 | 1200 | 100 | 612 | 97% | 94% |
| 4 | 36 | 8 | 8 | 1300 | 21 | 612 | 92% | 93% |
| 5 | 30 | 4 | 2 | 1200 | 50 | 510 | 103% | 90% |
| 6 | 30 | 15 | 16 | 1300 | 100 | 765 | 105% | 90% |

TABLE 2
Formulas of Examples 7-9 (unit: parts by weight, where the amount of water is the
initial content, DHA algal oil contains ≥40% of DHA) and texture test results

| | | Agar | Arabic | | | | Hardness | Elastic |
|---|---|---|---|---|---|---|---|---|
| | Carrageenan | (1000 | gum | Maltose | DHA algal oil | Purified | retention | retention |
| Example | (3243C) | g/cm²) | (SC10) | P200 | (40%) | water | rate | rate |
| 7 | 45 | 4 | 2 | 1200 | 20 | 765 | 95% | 96% |
| 8 | 36 | 8 | 8 | 1300 | 18 | 612 | 97% | 97% |
| 9 | 30 | 4 | 2 | 1200 | 16 | 510 | 97% | 95% |

TABLE 3
Formulas of Comparative Examples 1-6 (unit: parts by weight, where the amount of water
is the initial content, DHA algal oil contains ≥40% of DHA) and texture test results

| | | | | | DHA | | | |
|---|---|---|---|---|---|---|---|---|
| | | | Arabic | | algal | | Hardness | Elastic |
| Comparative | Carrageenan | Agar | gum | Maltose | oil | Purified | retention | retention |
| Example | (3243C) | (1000 g/cm²) | (SC10) | P200 | (40%) | water | rate | rate |
| 1 | 45 | 0 | 2 | 1200 | 21 | 765 | 69% | 76% |
| 2 | 45 | 0 | 16 | 1300 | 50 | 765 | 69% | 77% |
| 3 | 36 | 0 | 8 | 1200 | 100 | 612 | 67% | 74% |
| 4 | 36 | 0 | 8 | 1300 | 21 | 612 | 64% | 71% |
| 5 | 30 | 0 | 2 | 1200 | 50 | 510 | 62% | 69% |
| 6 | 30 | 0 | 16 | 1300 | 100 | 510 | 67% | 67% |

TABLE 4
Formulas of Comparative Examples 7-12 (unit: parts by weight, where the amount of water
is the initial content, DHA algal oil contains ≥40% of DHA) and texture test results

| | | | | | DHA | | | |
|---|---|---|---|---|---|---|---|---|
| | | | Arabic | | algal | | Hardness | Elastic |
| Comparative | Carrageenan | Agar | gum | Maltose | oil | Purified | retention | retention |
| Example | (3243C) | (1000 g/cm²) | (SC10) | P200 | (40%) | water | rate | rate |
| 7 | 45 | 4 | 0 | 1200 | 21 | 765 | 64% | 74% |
| 8 | 45 | 15 | 0 | 1300 | 50 | 765 | 62% | 77% |
| 9 | 36 | 8 | 0 | 1200 | 100 | 612 | 67% | 74% |
| 10 | 36 | 8 | 0 | 1300 | 21 | 612 | 64% | 71% |
| 11 | 30 | 4 | 0 | 1200 | 50 | 510 | 62% | 64% |
| 12 | 30 | 15 | 0 | 1300 | 100 | 510 | 61% | 67% |

TABLE 5
Formulas of Comparative Examples 13-15 (unit: parts by weight, where the amount of water
is the initial content, DHA algal oil contains ≥40% of DHA) and texture test results

| | | | | | DHA | | | |
|---|---|---|---|---|---|---|---|---|
| | | | Arabic | | algal | | Hardness | Elastic |
| Comparative | Carrageenan | Agar | gum | Maltose | oil | Purified | retention | Retention |
| Example | (3243C) | (1000 g/cm²) | (SC10) | P200 | (40%) | water | rate | rate |
| 13 | 30 | 3 | 2 | 1200 | 50 | 510 | 79% | 66% |
| 14 | 36 | 20 | 8 | 1300 | 21 | 612 | 73% | 67% |
| 15 | 45 | 3 | 16 | 1300 | 50 | 765 | 67% | 64% |

TABLE 6
Formulas of Comparative Examples 16-18 (unit: parts by weight, where the amount of water
is the initial content, DHA algal oil contains ≥40% of DHA) and texture test results

| | | | | | DHA | | | |
|---|---|---|---|---|---|---|---|---|
| | | | Arabic | | algal | | Hardness | Elastic |
| Comparative | Carrageenan | Agar | gum | Maltose | oil | Purified | retention | retention |
| Example | (3243C) | (1000 g/cm²) | (SC10) | P200 | (40%) | water | rate | rate |
| 16 | 30 | 4 | 1 | 1200 | 50 | 510 | 79% | 74% |
| 17 | 36 | 8 | 25 | 1200 | 100 | 612 | 72% | 87% |
| 18 | 45 | 15 | 1 | 1300 | 50 | 765 | 77% | 74% |

TABLE 7
Formulas of Comparative Examples 19-22 (unit: parts by weight, where the amount of water
is the initial content, DHA algal oil contains ≥40% of DHA) and texture test results

| | | | Arabic | | DHA | | Hardness | Elastic |
|---|---|---|---|---|---|---|---|---|
| Comparative | Carrageenan | Agar | gum | Maltose | algal oil | Purified | retention | retention |
| Example | (3243C) | (1000 g/cm²) | (SC10) | P200 | (40%) | water | rate | rate |
| 19 | 45 | 2 | 1 | 1200 | 21 | 675 | 54% | 64% |
| 20 | 45 | 20 | 22 | 1300 | 50 | 765 | 62% | 57% |
| 21 | 36 | 2 | 1 | 1200 | 100 | 612 | 57% | 54% |
| 22 | 30 | 2 | 1 | 1200 | 50 | 510 | 52% | 60% |

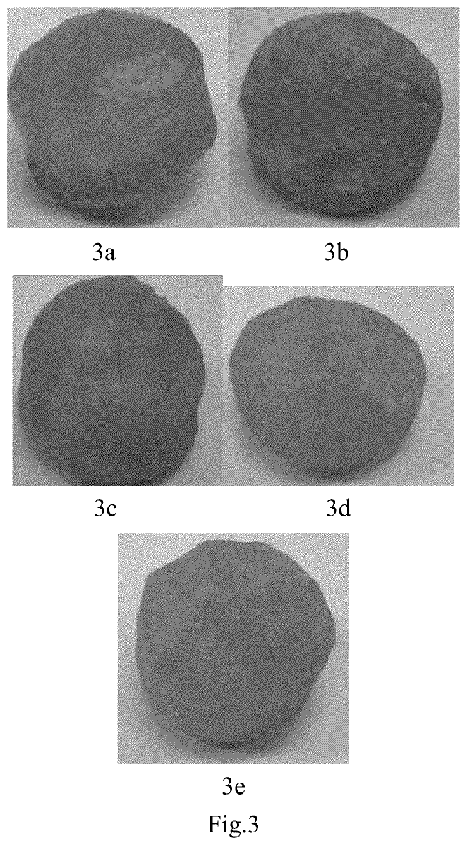

From Tables 1-7 and FIGS. 2-3, it can be seen that when the gum of the present disclosure contains a specified amount of carrageenan, agar and/or pectin and arabic gum and/or gellan gum, the resulting soft jelly candy product will not “shrink” during the shelf life, and the product has good texture retention. In addition, the soft jelly candy product of the present disclosure will not “shrink” even when it contains a high content of functional ingredients and contains sugar alcohols.

1. A vegetable gum-based soft jelly candy, comprising:
a) 30-45 parts by weight of carrageenan,
b) 4-15 parts by weight of agar and/or pectin, and
c) 2-16 parts by weight of arabic gum and/or gellan gum,
wherein the components a), b) and c) together account for 2.37-5.86% by weight based on the total weight of the soft jelly candy minus moisture.

2. The vegetable gum-based soft jelly candy according to claim 1, further comprising 21-100 parts by weight of a functional ingredient.

3. The vegetable gum-based soft jelly candy according to claim 1, further comprising 1200-1300 parts by weight of a sweetener.

4. The vegetable gum-based soft jelly candy according to claim 1, wherein the vegetable gum-based soft jelly candy is sugar-free.

5. The vegetable gum-based soft jelly candy according to claim 2, wherein the functional ingredient comprises a nutritional fortifier which is one or more of the nutritional fortifiers allowed for use in the current GB14880 Standard for the use of nutritional fortifiers.

6. The vegetable gum-based soft jelly candy according to claim 3, wherein the sweetener is one or more selected from the group consisting of sorbitol, mannitol, maltitol, isomaltitol, erythritol and xylitol.

7. The vegetable gum-based soft jelly candy according to claim 1, further comprising one or more components selected from 0-20 parts by weight of a fruit and vegetable juice, 0-20 parts by weight of a sour agent, 0-20 parts by weight of an edible essence and 0-20 parts by weight of a food pigment.

8. The vegetable gum-based soft jelly candy according to claim 1, comprising the following components:
I:
a) 36-45 parts by weight of carrageenan,
b) 8-15 parts by weight of agar and/or pectin, and
c) 8-16 parts by weight of arabic gum and/or gellan gum; or
II:
a) 30-45 parts by weight of carrageenan,
b) 4-8 parts by weight of agar and/or pectin, and
c) 2-8 parts by weight of arabic gum and/or gellan gum.

9. A method for preparing the vegetable gum-based soft jelly candy according to claim 1, wherein the method comprises homogeneously mixing each of carrageenan, agar and/or pectin and arabic gum and/or gellan gum with water.

10. A method for improving the appearance stability and/or texture of a vegetable gum-based soft jelly candy, comprising preparing the vegetable gum-based soft jelly candy with a) carrageenan, b) agar and/or pectin and c) arabic gum and/or gellan gum, wherein the vegetable gum-based soft jelly candy comprises the following components:
a) 30-45 parts by weight of carrageenan,
b) 4-15 parts by weight of agar and/or pectin, and
c) 2-16 parts by weight of arabic gum and/or gellan gum,
wherein the components a), b) and c) together account for 2.37-5.86% by weight based on the total weight of the soft jelly candy minus moisture.

11. The vegetable gum-based soft jelly candy according to claim 5, wherein the nutritional fortifiers are selected from the group consisting of minerals, vitamins, amino acids, and other ingredients beneficial to the human body.

12. The vegetable gum-based soft jelly candy according to claim 11, wherein the minerals are selected from the group consisting of calcium, iron, zinc, selenium, magnesium, potassium, sodium, and copper; the vitamins are selected from the group consisting of vitamin A, vitamin D, vitamin E, vitamin C, B vitamins, folic acid, and biotin; the amino acids are selected from the group consisting of taurine and lysine; and/or the other ingredients beneficial to the human body are selected from the group consisting of docosahexaenoic acid (DHA), dietary fiber, lecithin, and probiotics.
